(19) United States
(12) Patent Application Publication
(10) Pub. No.: US 2025/0244176 A1
(43) Pub. Date: Jul. 31, 2025

(54) Thermal Imaging Camera

(71) Applicant: Robert Bosch GmbH, Stuttgart (DE)

(72) Inventors: Axel Rumberg, Karlsruhe (DE); Michael Frank, Bretten (DE); Patrick Meyer, Leinfelden-Echterdingen (DE); Tim Saup, Leinfelden-Echterdingen (DE)

(21) Appl. No.: 18/986,024

(22) Filed: Dec. 18, 2024

(30) Foreign Application Priority Data
Dec. 22, 2023 (DE) 10 2023 213 295.8

(51) Int. Cl. G01J 5/08; G01J 5/02; G01J 5/04

(52) U.S. Cl. CPC G01J 5/0859; G01J 5/0265; G01J 5/04

(57) ABSTRACT

A thermal imaging camera includes a housing, a front bracket, an infrared assembly for detecting infrared radiation, and a visual assembly for receiving visual radiation. The infrared assembly and the visual assembly are disposed substantially within the housing. The camera further includes at least one cooling element for cooling at least the infrared assembly. The camera also includes a positioning device configured to position the visual assembly to the infrared assembly.

This application claims priority under 35 U.S.C. § 119 to patent application no. DE 10 2023 213 295.8, filed on Dec. 22, 2023 in Germany, the disclosure of which is incorporated herein by reference in its entirety.

The present disclosure relates to a thermal imaging camera.

### BACKGROUND

A handheld thermal imaging camera for contact-free determination of two-dimensional temperature information of a scene, comprising a housing with at least one infrared detector array consisting of a plurality of pixels sensitive to infrared radiation, is already known from DE 10 2016 219 388 A1.

### SUMMARY

The present disclosure proceeds from a thermal imaging camera with a housing, with a front bracket, with an infrared assembly for detecting infrared radiation, with a visual assembly for recording visual radiation, wherein the infrared assembly and the visual assembly are substantially disposed within the housing, and with at least one cooling element for cooling at least the infrared assembly. It is proposed that the thermal imaging camera comprises a positioning device configured to position the visual assembly to the infrared assembly.

The disclosure provides a thermal imaging camera in which thermal influences can be reduced by the positioning device positioning the visual assembly to the infrared assembly.

A “thermal image camera” refers to a device for non-contact measurement of two-dimensional temperature information of a scene which outputs at least one piece of information relating to the two-dimensional temperature information, for example by outputting one or more temperature indicators, advantageously two or more temperature readings, a temperature distribution, or the like. In one embodiment of the thermal imaging camera, this two-dimensional temperature information may be in the form of a thermal image composed of a plurality of spatially-resolved temperature readings and/or temperature readings resolved for the spatial angle.

The thermal imaging camera may be configured as a handheld thermal imaging camera. The “handheld” thermal imaging camera is to be understood in particular to mean that the thermal imaging camera can only be transported with the hands, in particular with one hand, of a user without the aid of a hauling machine. In particular, the thermal imaging camera can also be handheld and guided through a room during a measurement operation in a movement freely performed by the user of the thermal imaging camera. The mass of the handheld thermal imaging camera is in particular less than 5 kg, advantageously less than 3 kg, and particularly advantageously less than 1 kg.

The housing can be configured as a shell housing with two half shells. The housing comprises a handle or a handle area with which the thermal imaging camera can be guided by the user. The housing accommodates at least essential functional components of the thermal imaging camera. Thus, the infrared assembly and the visual assembly are substantially disposed inside the housing. Further, the front bracket, the cooling element and/or the positioning device may be substantially disposed within the housing. Further, the housing accommodates at least a control unit, an input and/or an output device, in particular a display device, a power supply unit, and an evaluation unit. The thermal imaging camera may comprise at least one operating element configured to operate the thermal imaging camera. Further, the housing may comprise at least one inlet opening into which the visual radiation and/or infrared radiation may enter.

The front bracket may be received by the housing. The front bracket may close off the housing from a surrounding environment. The functional components of the thermal imaging camera may be substantially protected from environmental influences inside the housing. The front bracket has an opening for the infrared assembly and the visual assembly. The front bracket has a receptacle for the visual assembly. The receptacle for the visual assembly is configured to at least partially surround the visual assembly. A face of the visual assembly may abut the receptacle of the front bracket. It is possible that the visual assembly may abut the front bracket, in particular the receptacle of the front bracket, by way of a visual lens. For example, the front bracket may be made of a heat-conductive material such as aluminum.

The visual assembly comprises at least one visual camera for capturing at least one image and/or video in the visual spectrum of radiation, a lens for the visual camera, and a circuit board for the visual camera. The visual assembly, in particular the circuit board for the visual camera, is connected to the control unit to receive signals. The lens for the visual camera is configured to break, bundle, and/or focus the visual radiation and direct it to the visual camera.

In addition, the front bracket comprises a further receptacle. The further receptacle of the front bracket may comprise an adhesive layer or an adhesive pad. The further receptacle of the front bracket is configured to receive at least one infrared window and/or pane of glass for the visual assembly. Further, it is possible that the further receptacle of the front bracket will receive a laser and a lens for a light source, for example, such as an LED. Further, a seal may be applied to and/or glued to the front bracket.

The infrared assembly may comprise an infrared housing, an infrared sensor, an infrared lens, and/or an infrared circuit board. The infrared housing is configured to position the infrared optics relative to the infrared sensor. The infrared sensor may be configured as an infrared detector array. It is also conceivable that the infrared sensor is configured as a bolometer, in particular a micro-bolometer. To measure infrared radiation, the thermal imaging camera comprises the infrared assembly as well as the evaluation unit. The infrared sensor comprises a plurality of pixels sensitive to infrared radiation. The infrared sensor detects infrared radiation radiated in a spatial angle region and projected on its surface and generates a detection signal based on a detected intensity of incident infrared radiation. The infrared sensor has a two-dimensional detecting area on a surface facing the scene, on which the plurality of pixels sensitive to infrared radiation are arranged. Each of the pixels of the infrared detector array can thereby determine—provided that they are illuminated by way of infrared radiation—image information and generate a detection signal therefrom. The detection signal provided by each pixel may then be used to determine temperature information. In particular, the detection signal of each pixel may be forwarded to the evaluation unit of the thermal imaging camera. The detection signal can be evaluated by the evaluation unit individually and/or in combination with detection signals of other pixels. The infrared lens is configured to break, bundle, and/or focus the infrared radiation and direct it onto the infrared sensor. The infrared sensor may be disposed on the infrared circuit board. Thus, the infrared sensor may be disposed between the infrared circuit board and the infrared lens. The infrared circuit board is connected to the control unit and/or the evaluation unit to receive signals, such that the detection signal can be conducted from the infrared assembly to the control unit and/or the evaluation unit. The infrared assembly may at least partially engage with a recess of the front bracket. The infrared assembly can engage the recess by way of the infrared lens. The infrared assembly may define an optical axis, which may be a primary direction of incidence for the infrared radiation. “Axial” is in particular intended to be understood as substantially parallel to the optical axis. Whereas “radial” is intended to be understood as substantially perpendicular to the optical axis.

The thermal imaging camera comprises the control unit at least for controlling the infrared assembly and/or the visual assembly. For this purpose, the control unit is connected to at least the infrared assembly and the visual assembly to receive signals. Further, the control unit is connected to the evaluation unit to receive signals. The control unit can be disposed, for example, in a handle of the handheld tool, in an area of a power supply interface, or in an area of the infrared assembly and/or the visual assembly. The control unit has at least a main circuit board. The main circuit board may be disposed opposite the front bracket. For example, the main circuit board may be disposed towards the output device.

The “evaluation unit” of the thermal imaging camera is to be understood as a unit comprising at least one information input for receiving detection signals, an information processing unit for processing, in particular evaluating the received detection signals, and an information output for passing on the processed and/or evaluated detection signals and/or evaluation information. Advantageously, the evaluation unit contains components comprising at least a processor, a memory, and an operating program with evaluation and calculation routines. In particular, the electronic components of the evaluation unit can be arranged on a board or printed circuit board, preferably on a common board with the control unit of the thermal imaging camera for controlling the thermal imaging camera. Furthermore, the control unit and the evaluation unit can also be designed as a single component, for example in the form of a microcontroller. The evaluation unit is provided to evaluate detection signals generated by the infrared detector array, in particular from the pixels which can be connected to the analysis unit to receive signals, and to perform an analysis of the two-dimensional temperature information of the scene based on the detection signals of at least a plurality of illuminated pixels of the infrared detector array. Preferably, the evaluation unit is provided to perform an evaluation of one or more temperature metrics, in particular also averaged temperature metrics, particularly preferably a thermal image, based on the detection signals of at least a plurality of illuminated pixels. In this way, the evaluation unit serves to determine the two-dimensional temperature information, in particular the thermal image, from measured infrared radiation. The evaluated two-dimensional temperature information, in particular the thermal image, may be provided by the evaluation unit for further processing and/or output to the user of the thermal imaging camera by way of the output device and/or an external device via a data communication interface.

The output device is configured to represent the two-dimensional temperature information, in particular the thermal image, and to provide and display information to the user. The output device can be designed as a display, for example. The output device may be disposed opposite the front bracket on the housing. For example, the output device may play the images or videos of the visual assembly and/or the detection signal of the infrared assembly.

The input device is configured to receive and at least forward input from the user to the control unit. The input device may comprise at least one operating element. For example, the operating element may be configured to turn the thermal imaging camera on and/or off, take a photo of a scene, set an operating mode, or activate another function of the thermal imaging camera.

The cooling element is configured to cool at least the infrared assembly. The cooling element may be disposed opposite to the front bracket, in particular substantially inside the housing. The cooling element may be disposed axially along the optical axis between the front bracket and the output device. The cooling element is made of a thermally conductive material. The cooling element absorbs and dissipates heat from at least the visual assembly and the infrared assembly to reduce, in particular to minimize, thermal interference.

The positioning device mechanically positions the visual assembly to the infrared assembly. By way of example, the positioning device may be configured as a type of frame, shell or canister. The positioning device may be formed about the optical axis. In addition, the positioning device is configured to thermally insulate the infrared assembly from the visual assembly. Further, the positioning device is configured to reduce interference radiation on the infrared assembly. The positioning device is made primarily from a non-heat-conductive, i.e. heat insulating, material. Because of this, the positioning device may thermally decouple the cooling element from the front bracket.

The energy supply unit is equipped for battery operation by way of batteries, for operation by rechargeable batteries with rechargeable battery packs, in particular hand-held power tool rechargeable battery packs and/or for plug-in operation. The power supply unit is provided at least for supplying power to the thermal imaging camera. In a preferred embodiment, the power supply is configured for cordless operation. In the context of the present disclosure, a “hand-held power tool rechargeable battery pack” is intended to be understood as a combination of at least one battery cell and a rechargeable battery pack housing. The hand-held power tool rechargeable battery pack is advantageously configured for supplying power to commonly available cordless hand-held power tools. The at least one battery cell can, for instance, be configured as a Li-ion battery cell having a nominal voltage of 3.6 V. The hand-held power tool rechargeable battery pack can include up to ten battery cells, for example, although a different number of battery cells is conceivable too. Both an embodiment as a cordless hand-held power tool and operation as a mains-operated hand-held power tool are sufficiently well-known to those skilled in the art, so the specifics of the power supply will not be discussed here.

In one embodiment of the thermal imaging camera, the positioning device is arranged, in particular axially along the optical axis, between the front bracket and the cooling element. At least the infrared assembly abuts the cooling element by way of the infrared circuit board. The cooling element comprises a receptacle for the infrared assembly. The receptacle of the cooling element is configured to at least partially receive the infrared assembly. The positioning device is adjacent at least partially and/or at least in sections to the cooling element and/or the front bracket. The cooling element may at least partially engage with the positioning device.

In one embodiment of the thermal imaging camera, the infrared assembly and the visual assembly are positioned overlappingly with each other by way of the positioning device. The infrared assembly and the visual assembly may axially overlap relative to the optical axis. For example, at least the infrared lens and the circuit board for the visual camera overlap. The infrared assembly and the visual assembly may be disposed radially, particularly to the optical axis, spaced apart from one other.

In one embodiment of the thermal imaging camera, the positioning device comprises at least one receptacle for the infrared assembly which at least partially surrounds the infrared assembly. The receptacle of the positioning device for the infrared assembly can, for example, be configured as an opening or a recess. The receptacle for the positioning device for the infrared assembly can be configured, for example, to be round, elliptical or polygonal, such as triangular or quadrilateral. The receptacle of the positioning device for the infrared assembly can at least partially surround the infrared housing. The infrared housing may be adjacent to or be spaced apart from the receptacle of the positioning device for the infrared assembly. The receptacle may comprise at least two bars arranged opposite to one another. By way of example, four abutting bars that abut the infrared housing may be provided. By way of example, the receptacle of the positioning device for the infrared assembly substantially completely surrounds the infrared housing. The receptacle of the positioning device for the infrared assembly may fix the infrared housing relative to the visual assembly.

In one embodiment of the thermal imaging camera, the positioning device comprises a receptacle for the visual assembly at least partially surrounding the visual assembly. The receptacle of the positioning device for the visual assembly may at least partially receive the visual assembly. In this configuration, the visual assembly may only partially abut the receptacle of the positioning device for the visual assembly. The receptacle of the positioning device for the visual assembly may at least partially surround the board for the visual camera. The receptacle of the positioning device for the infrared assembly and the receptacle of the positioning device for the visual assembly may be positioned radially offset, in particular to the optical axis, from one another on the positioning device. Accordingly, the infrared assembly and the visual assembly may be arranged radially with respect to one other. For example, the receptacle of the positioning device for the visual assembly may be shell-like, cup-like, frame-like, or shelf-like. The receptacle of the positioning device for the visual assembly may comprise at least one abutment element disposed between and at least partially abutting the circuit board of the visual camera. For example, the abutment element may be configured as bars.

In one embodiment of the thermal imaging camera, the positioning device comprises at least one shielding element configured to shield the infrared assembly against thermal radiation from the visual assembly. The shielding element may be connected to the positioning device. The positioning device may form the shielding element. It is possible that the shielding element and the positioning device may be of a single piece. The shielding element may extend axially along the optical axis. For example, the shielding element may be disposed towards the front bracket and away from the infrared assembly. The shielding element can be designed in the form of a bar, a protrusion, or an edge, for example.

In one embodiment of the thermal imaging camera, the front bracket comprises at least one insulating element configured to insulate the infrared assembly. The insulating element may be connected to the front bracket. It is possible that the front bracket may form the insulating element so that it is a single piece. The insulating element may extend axially along the optical axis. The insulating element may extend towards the infrared assembly. The insulating element may be configured, for example, in the form of a bar, a protrusion, or an edge. The insulating element may prevent and/or reduce thermal radiation from the visual assembly towards the infrared assembly.

In one embodiment of the thermal imaging camera, the shielding element abuts the insulating element. When the thermal imaging camera is assembled, the shielding element may abut the insulating element. This allows the shielding element and the insulating element to form a common bar that substantially shields the infrared assembly against thermal radiation from the visual assembly.

In one embodiment of the thermal imaging camera, the positioning device comprises at least one positioning element configured to position the front bracket relative to the infrared assembly and/or the visual assembly. The positioning device may be connected to the positioning element. The positioning device may form the positioning element, so that it may be a single piece. The positioning element orients the front bracket relative to the infrared assembly and/or the visual assembly such that openings in the front bracket are axially aligned with the infrared assembly and/or the visual assembly respectively. For example, the positioning element may be sleeve-like, cylindrical, bar-like, or designed as a screw boss. The positioning element may engage in the front bracket. The front bracket may comprise a receptacle for this purpose, wherein the positioning element may engage the receptacle in at least a positive-locking manner. A plurality of positioning elements may be provided, for example two, three, four or more than four.

In one embodiment of the thermal imaging camera, the cooling element comprises at least one alignment element and the positioning device comprises at least one receptacle for the alignment element, wherein the alignment element is configured to align the positioning device relative to the cooling element by way of the receptacle for the alignment element. The alignment element may be connected to the cooling element. The cooling element may form the alignment element so that it is a single piece. The alignment element may engage with the receptacle of the positioning device for the alignment element in at least a positive-locking manner. For example, the alignment element may be formed as a tenon, pin, bolt, protrusion, or bar. A plurality of alignment elements may be provided, for example, two, three, or more than three.

### BRIEF DESCRIPTION OF THE DRAWINGS

The disclosure is explained in more detail in the following with reference to a preferred embodiment. In the following, the drawings show:

FIG. 1a a schematic front view of a thermal imaging camera according to the disclosure;

FIG. 1b a schematic rear view of a thermal imaging camera according to the disclosure;

FIG. 2 a section of a longitudinal sectional view of the thermal imaging camera;

FIG. 3 an exploded view of a front bracket, a positioning device, a cooling element, an infrared assembly, and a visual assembly;

FIG. 4a a front perspective view of the positioning device;

FIG. 4b a rear perspective view of the positioning device;

### DETAILED DESCRIPTION

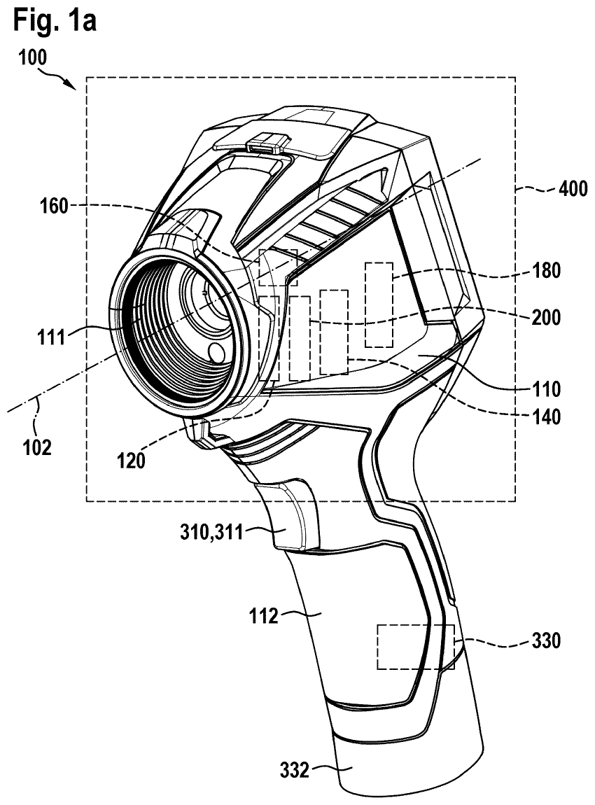

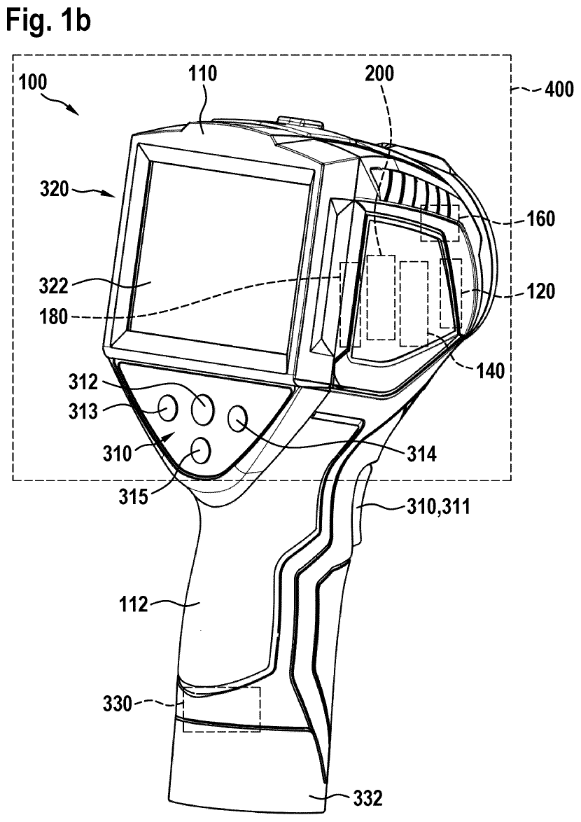

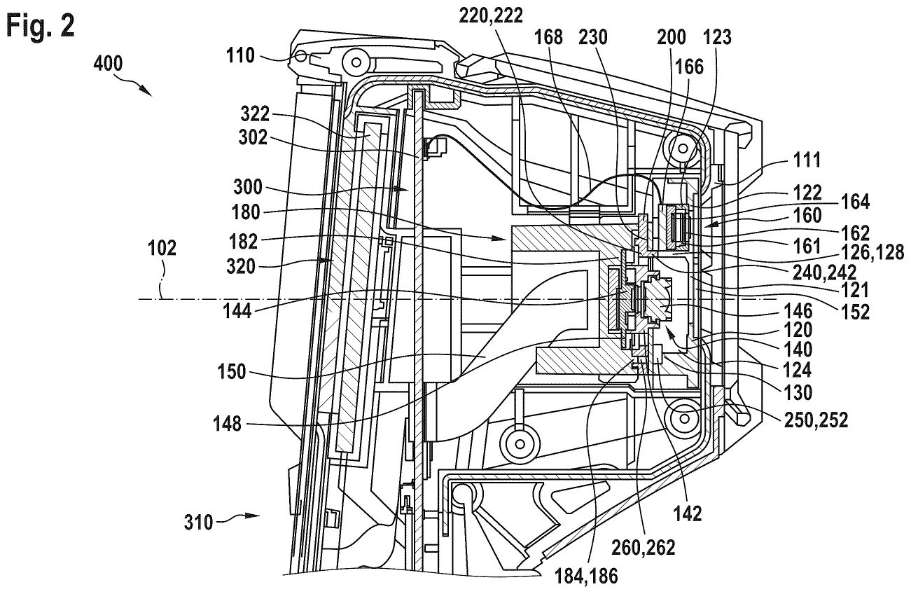

FIG. 1a shows a schematic front view of a thermal imaging camera 100 according to the disclosure, wherein FIG. 1b shows a schematic rear view of the thermal imaging camera 100. The thermal imaging camera 100 here is formed as a handheld thermal imaging camera 100, for example. The thermal imaging camera 100 comprises a housing 110, a front bracket 120, an infrared assembly 140 for detecting infrared radiation, a visual assembly 160 for receiving visual radiation, and at least one cooling element 180 for cooling at least the infrared assembly 140, see also FIGS. 2 to 4. The infrared assembly 140 and the visual assembly 160 are substantially disposed within the housing 110. The thermal imaging camera 100 comprises a positioning device 200, see also FIGS. 2 to 4. The positioning device 200 is provided to position the visual assembly 160 to the infrared assembly 140.

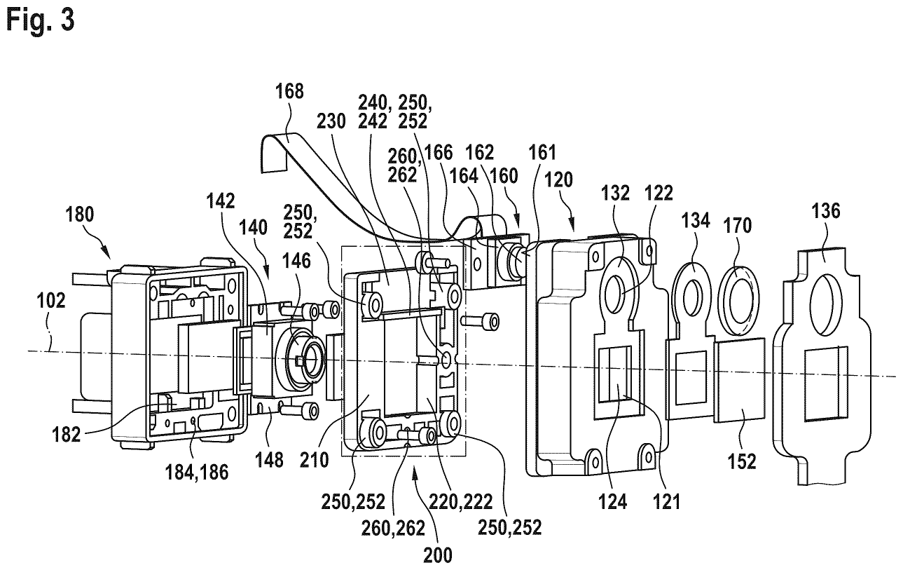

The housing 110 is formed as a shell housing with two half shells. The housing 110 also comprises a handle 112. The front bracket 120, the cooling element 180 and the positioning device 200 are substantially disposed within the housing 110, see also FIGS. 2 and 3. The housing 110 receives a control unit 300, an input device 310, an output device 320, a power supply unit 330, and an evaluation unit, which is not shown. For example, the input device 310 comprises five operating elements 311, 312, 313, 314, 315, see also FIG. 1b. The five operating elements 311, 312, 313, 314, 315 are provided to operate the thermal imaging camera 100. A first operating element 311 is configured as a trigger by which images may be taken. A second operating element 312 is configured as a button by which a user can turn the thermal imaging camera 100 on and off and access a menu selection. A third operating element 313 and a fourth operating element 314 are configured to switch between operating modes within the menu selections. A fifth operating element 315 is configured to confirm and activate a desired operating mode. The assignments of the operating elements 311, 312, 313, 314, 315 are only examples here, so that it is clear to the person skilled in the art that the assignments may also be different. The output device 320 is provided to represent two-dimensional temperature information, in particular a thermal image, and to provide and display information to the user. The output device 320 is formed as a display 322, for example, see FIG. 1b. The output device 320 is disposed opposite to the front bracket 120 on the housing 110. The power supply unit 330 is configured for battery operation using a hand-held power tool rechargeable battery pack 332. The power supply unit 330 is configured to at least supply power to the thermal imaging camera 100. The housing comprises an inlet opening 111. Visual radiation and/or infrared radiation may enter the inlet opening 111. The infrared assembly 140 defines an optical axis 102 that is a primary direction of incidence for the infrared radiation and/or the visual radiation through the inlet opening 111.

FIG. 2 shows a section 400 of a longitudinal sectional view of the thermal imaging camera 100. The cooling element 180 is formed to cool at least the infrared assembly 140, wherein it is made from a thermally conductive material. The cooling element 180 is disposed opposite the front bracket 120. The cooling element 180 is disposed axially along the optical axis 102 between the front bracket 120 and the output device 300. The housing 110 receives the front bracket 120. The front bracket 120 comprises an opening 121 for the infrared assembly and an opening 122 for the visual assembly 160. The front bracket 120 comprises a receptacle 123 for the visual assembly 160. The receptacle 123 for the visual assembly 160 at least partially surrounds the visual assembly 160. The visual assembly 160 abuts the receptacle 123 of the front bracket 120 by way of an end face 161. The visual assembly 160 abuts the front bracket 120 by way of a visual lens 162. The visual assembly 160 comprises a visual camera 164 for capturing at least one image and/or video in the visual spectrum of radiation, the lens 162 for the visual camera 164, and a circuit board 166 for the visual camera 164. The visual assembly 160, in particular the circuit board 166 for the visual camera 164, is connected to the controller 300 to receive signals by way of a cable 168.

The infrared assembly 140 comprises an infrared housing 142, an infrared sensor 144, an infrared lens 146, an infrared circuit board 148, and a connection cable 150. The infrared housing 142 positions the infrared lens 146 relative to the infrared sensor 144. The infrared sensor 144 is formed as an infrared detector array. To measure infrared radiation, the thermal imaging camera 100 comprises the infrared assembly 140 as well as the evaluation unit. The infrared assembly 140 is connected to the evaluation unit by way of the connection cable 150, wherein the control unit 300 comprises the evaluation unit. The infrared lens 146 bundles incident infrared radiation through the inlet opening 111 and directs it to the infrared sensor 144. The infrared sensor 144 is disposed on the infrared circuit board 148, wherein the infrared sensor 144 is disposed between the infrared circuit board 148 and the infrared lens 146. The infrared circuit board 148 is connected to the control unit 300 by way of the connection cable 150. The infrared assembly 140 at least partially engages in a recess 124 of the front bracket 120, wherein the infrared assembly 140 engages in the recess 124 by way of the infrared lens 146.

The control unit 300 is connected to the infrared assembly 140 to receive signals by way of the connection cable 150 and to the visual assembly 160 by way of the cable 168. The control unit 300 comprises a main circuit board 302 that is disposed opposite the front bracket 120. The main circuit board 302 is disposed, particularly axially to the optical axis 102, between the front bracket 120 and the output device 320. In addition, the main circuit board 302 is disposed axially, particularly to the optical axis 102, between the cooling element 180 and the output device 320.

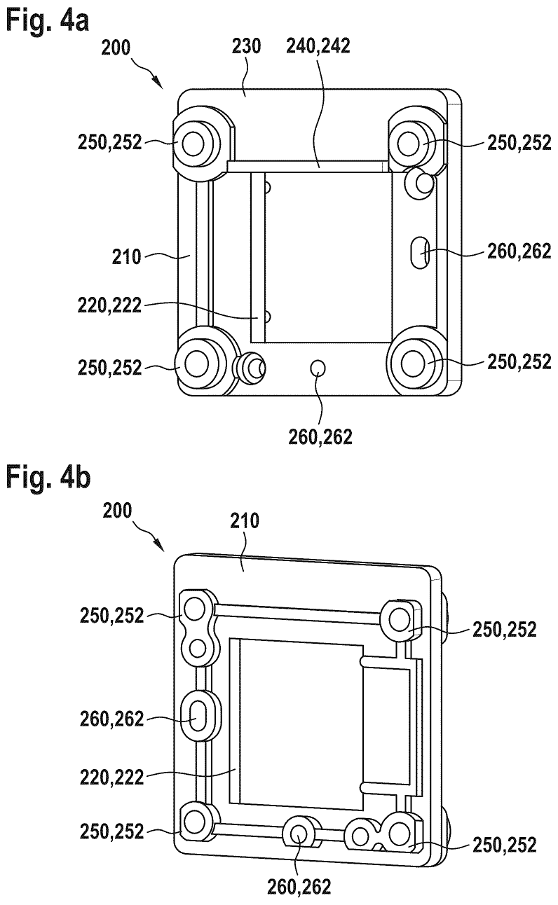

The positioning device 200 is configured to mechanically position the visual assembly 160 to the infrared assembly 140. The positioning device 200 is, for example, formed as a frame 210, see also FIGS. 3 to 4. The positioning device 200 is disposed about the optical axis 102 and thermally insulates the infrared assembly 140 from the visual assembly 160. The positioning device 200 thermally decouples the cooling element 180 from the front bracket 120. The positioning device 200 is disposed axially along the optical axis 102 between the front bracket 120 and the cooling element 180. The infrared assembly 140 abuts the cooling element 180 by way of the infrared circuit board 148. The cooling element 180 comprises a receptacle 182 for the infrared assembly 140. The receptacle 182 of the cooling element 180 at least partially receives the infrared assembly 140. The positioning device 200 abuts the cooling element 180 and the front bracket 120 at least in part and/or in sections. In addition, the cooling element 180 at least partially engages with the positioning device 200. The infrared assembly 140 and the visual assembly 160 are arranged as overlapping with one another by way of the positioning device 200, in particular axially along the optical axis 102. Here, at least the infrared lens 146 and the circuit board 166 for the visual camera 164 overlap. The infrared assembly 140 and the visual assembly 160 are disposed radially, particularly with respect to the optical axis 102, spaced apart from one other. The positioning device 200 comprises a receptacle 220 for the infrared assembly 140. The receptacle 220 for the infrared assembly 140 at least partially surrounds, in particular substantially completely surrounds, the infrared assembly 140. The receptacle 220 of the positioning device 200 for the infrared assembly 140 is shaped, for example, as a quadrilateral opening 222, see also FIGS. 3 and 4. The receptacle 220 of the positioning device 200 for the infrared assembly 140 at least partially surrounds the infrared housing 142. The receptacle 220 of the positioning device 200 for the infrared assembly 140 is spaced from the infrared assembly here such that there is a distance between the infrared housing 142 and the receptacle 220. The positioning device 200 comprises a receptacle 230 for the visual assembly 160. The receptacle 230 of the positioning device 200 for the visual assembly 160 surrounds the visual assembly 160 at least in part and receives it at least in part. The visual assembly 160 abuts only part of the receptacle 230 of the positioning device 200 for the visual assembly 160. The receptacle 230 of the positioning device 200 for the visual assembly 160 at least partially surrounds the board 166 for the visual camera 164. The receptacle 220 of the positioning device 200 for the infrared assembly 140 and the receptacle 230 of the positioning device 200 for the visual assembly 160 are radially offset, in particular to the optical axis 102, from one other on the positioning device 200. The receptacle 230 of the positioning device 200 for the visual assembly 160 is, for example, cup-shaped.

The positioning device 200 comprises a shielding element 240. The shielding element 240 is provided to shield the infrared assembly 140 against thermal radiation from the visual assembly 160. By way of example, the positioning device 200 forms the shielding element so that it is a single piece here. The shielding element 240 extends axially along the optical axis 102. The shielding element 240 extends towards the front bracket 120. The shielding element 240 is formed as a shielding bar 242, for example. The front bracket 120 comprises an insulating element 126. The insulating element 126 is provided to insulate the infrared assembly 140. The front bracket 120 forms the insulating element 126 so that it is a single piece. The insulating element 126 extends axially along the optical axis 102 towards the infrared assembly 140 and the cooling element 180. The insulating element 126 is formed as an insulating bar, for example. The shielding element 240 abuts the insulating element 126. The positioning device 200 comprises at least one positioning element 250. The positioning element 250 is provided to position the front bracket 120 relative to the infrared assembly 140 and the visual assembly 160. The positioning device 200 forms the positioning element 250, so that it is a single piece. The positioning element 250 orients the front bracket 120 relative to the infrared assembly 140 and the visual assembly 160 such that the opening 121 in the front bracket 120 for the infrared assembly 140 and the opening 122 in the front bracket 120 for the visual assembly 160 are axially aligned with the infrared assembly 140 and the visual assembly 160, respectively. The positioning element 250 is formed as a screw boss 252, by way of example, wherein four positioning elements 250 are provided here. The positioning element 250 engages in the front bracket 120. The front bracket 120 comprises a receptacle 130 for the positioning element 250. The receptacle 130 for the positioning element 250 receives the positioning element 250 in at least a positive-locking manner. By way of example, four receptacles 130 are formed for each of the positioning elements 250. The cooling element 180 comprises at least one alignment element 184. The positioning device 200 comprises at least one receptacle 260 for the positioning element 184. The positioning element 186 is provided to align the positioning device 200 relative to the cooling element 180 by way of the receptacle 260 for the positioning element 186. The cooling element 180, by way of example, forms the alignment element 184 so that it is a single piece. The positioning element 186 engages with the receptacle 260 of the positioning device 200 for the positioning element 184 in at least a positive-locking manner. The alignment element 184 is shaped as an alignment pin 186, for example. Here, for example, two alignment pins 186 and two receptacles 260 are formed, see also FIGS. 3 and 4. Each of the receptacles 260 is formed as a through-opening 262.

FIG. 3 shows an exploded view of the front bracket 120, the positioning device 200, the cooling element 180, the infrared assembly 140, and the visual assembly 160. The front bracket 120 comprises a further receptacle 132. The further receptacle 132 of the front bracket 120 comprises an adhesive pad 134. The further receptacle 132 of the front bracket 120 is provided to receive an infrared window 152 for the infrared assembly 140 and a glass pane 170 for the visual assembly 160 via the adhesive pad 134. A gasket 136 is affixed to the front bracket 120 to close off the housing 110 against a work environment.

FIG. 4a shows a front perspective view of the positioning device 200, wherein FIG. 4b shows a rear perspective view of the positioning device 200.

What is claimed is:

1. A thermal imaging camera, comprising:
a housing;
a front bracket;
an infrared assembly configured to detect infrared radiation;
a visual assembly configured to receive visual radiation, wherein the infrared assembly and the visual assembly are disposed substantially within the housing;
at least one cooling element configured to cool at least the infrared assembly; and
a positioning device configured to position the visual assembly in relation to the infrared assembly.

2. The thermal imaging camera according to claim 1, wherein the positioning device is disposed between the front bracket and the cooling element.

3. The thermal imaging camera according to claim 1, wherein the infrared assembly and the visual assembly are arranged overlapping with one another by way of the positioning device.

4. The thermal imaging camera according to claim 1, wherein the positioning device comprises at least one receptacle for the infrared assembly that at least partially surrounds the infrared assembly.

5. The thermal imaging camera according to claim 1, wherein the positioning device comprises a receptacle for the visual assembly that at least partially surrounds the visual assembly.

6. The thermal imaging camera according to claim 1, wherein the positioning device comprises at least one shielding element configured to shield thermal radiation from the visual assembly toward the infrared assembly.

7. The thermal imaging camera according to claim 1, wherein the front bracket comprises at least one insulating element configured to insulate the infrared assembly.

8. The thermal imaging camera according to claim 6, wherein the shielding element abuts the insulating element.

9. The thermal imaging camera according to claim 1, wherein the positioning device comprises at least one positioning element configured to position the front bracket relative to the infrared assembly and/or the visual assembly.

10. The thermal imaging camera according to claim 1, wherein the cooling element comprises at least one alignment element and the positioning device comprises at least one receptacle for the alignment element, and wherein the alignment element is configured to align the positioning device by way of the receptacle for the alignment element relative to the cooling element.
